(19) United States
(12) Patent Application Publication
(10) Pub. No.: US 2015/0373171 A1
(43) Pub. Date: Dec. 24, 2015

(54) Systems and Methods for Providing Access to Hosted Services by way of a User-Wearable Headset Computing Device

(71) Applicant: Verizon Patent and Licensing Inc., Arlington, VA (US)

(72) Inventor: Ramesh Marimuthu, Edison, NJ (US)

(21) Appl. No.: 14/308,533

(22) Filed: Jun. 18, 2014

(51) Int. Cl. H04M 1/05; H04W 88/06; H04M 3/493; H04M 1/11; H04N 7/15

(52) U.S. Cl. CPC H04M 1/05; H04M 1/11; H04N 7/15; H04M 3/493; H04W 88/06; H04M 2201/50

(57) ABSTRACT

An exemplary system includes a user-wearable headset computing device, a service gateway device communicatively coupled to the user-wearable headset computing device by way of a wireless network, and a plurality of server devices communicatively coupled to the service gateway device and that provide a plurality of hosted services for access by the user-wearable headset computing device by way of the service gateway device. In certain examples, the plurality of hosted services comprises at least a multi-persona phone service. In certain examples, an interactive voice response user interface to the plurality of hosted services is provided. Corresponding systems and methods are also described.

### BACKGROUND INFORMATION

Cloud computing allows computing resources in a network of servers to be used to run applications and/or deliver services. Such applications and/or services, which may be referred to as cloud services, may be an alternative solution to a computing architecture in which applications and/or services are run by local computers. As an example, instead of storing data to memory of a local user computer, a user may store the data to a network of servers in the “cloud.”

While cloud services have grown in popularity, there remains room to improve existing cloud services and devices and user interfaces used to access cloud services. For example, there remains room to improve the accessibility of and/or user experience with cloud services.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical reference numbers designate identical or similar elements.

FIG. 1 illustrates an exemplary hosted-service access system according to principles described herein.

FIG. 2 illustrates an exemplary peripheral device connected to a headset device in the system of FIG. 1 according to principles described herein.

FIGS. 3-4 illustrate exemplary implementations of the system of FIG. 1 according to principles described herein.

FIGS. 5-8 illustrate exemplary configurations of hosted services according to principles described herein.

FIG. 9 illustrates an exemplary hosted-service access method according to principles described herein.

FIG. 10 illustrates an exemplary computing device according to principles described herein.

### DETAILED DESCRIPTION OF PREFERRED EMBODIMENTS

Exemplary systems and methods for providing access to hosted services by way of a user-wearable headset computing device are described herein. Exemplary systems and methods described herein may provide a user of a user-wearable headset computing device with a convenient, intuitive, and/or feature-rich way to access and use cloud services provided by one or more cloud service providers.

As an example, an exemplary system may include a user-wearable headset computing device, a service gateway device communicatively coupled to the user-wearable headset computing device by way of a wireless network, and a plurality of server devices communicatively coupled to the service gateway device and that provide a plurality of hosted services for access by the user-wearable headset computing device by way of the service gateway device. Through the user-wearable headset computing device and the service gateway device, a user of the user-wearable headset computing device may access and use one or more of the hosted services, examples of which are described herein.

Exemplary hosted-service access systems and methods will now be described in reference to the drawings.

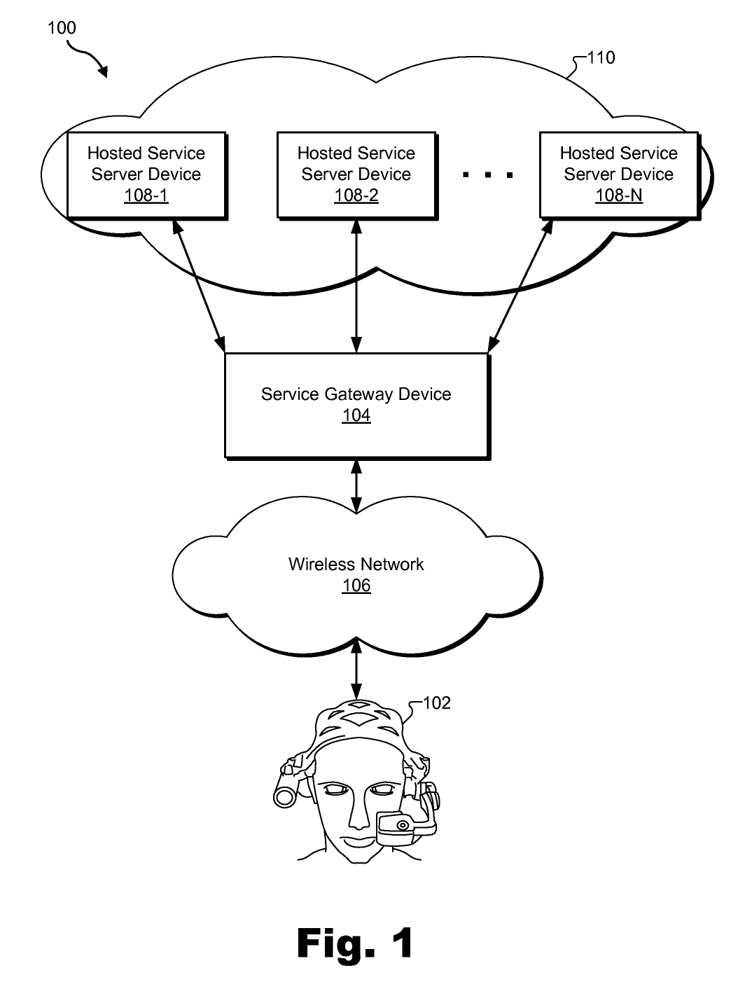

FIG. 1 illustrates an exemplary hosted-service access system 100 (“system 100”). As shown, system 100 may include a user-wearable headset computing device 102 (“headset device 102”) communicatively coupled to a service gateway device 104 (“gateway device 104”) by way of a wireless network 106. Gateway device 104 may also be communicatively coupled to a plurality of hosted service server devices 108 (e.g., server devices 108-1 through 108-N) that provide a plurality of hosted services for access by headset device 102 through gateway device 104. The hosted services may be cloud services, as represented by cloud 110.

The hosted services may be provided by server devices 108 for access by headset device 102 through gateway device 104 in any suitable way. For example, server devices 108 may include computing devices implementing application servers and/or any other type of servers configured to execute server operations and/or communicate with headset device 102 by way of gateway device 104 to facilitate access to and/or use of the hosted services by a user of headset device 102. In certain examples, one or more of server devices 108 may access and use other resources to provide hosted services, such as by access and using other hosted resources and/or distributed resources communicatively connected to the server devices 108.

The hosted services may be offered by one or more hosted service providers (e.g., cloud service providers), which may operate services devices 108. In certain examples, a set of hosted services may be offered as a package of multiple hosted services (e.g., a subscription package of hosted services). In certain examples, a single service provider may offer the set of hosted services. In certain examples, the single service provider that offers the set of hosted services may also provide (e.g., operate) gateway device 104 and/or wireless network 106. For example, a telecommunications service provider may operate wireless network 106, gateway device 104, and one or more of server devices 108.

Examples of hosted services may include, without limitation, voice communication services (e.g., a multi-persona phone service), content storage and management services (e.g., a media content storage and/or management service), gaming services, Internet access services, social media services, remote healthcare services (e.g., an remote interactive healthcare service), location-based service, other suitable hosted services, or any combination or sub-combination thereof. Certain examples of hosted services are described in more detail herein.

Gateway device 104 may include one or more computing devices configured to facilitate communications between server devices 108 and headset device 102. Gateway device 104 may communicate with server devices 108 using any suitable communication technologies, devices, media, protocols, and/or networks supportive of signaling and/or data communications, including, but not limited to, the Internet, intranets, local area networks, wide area networks, other data communications networks, data transmission media, communications devices, network elements, Transmission Control Protocol (“TCP”), Internet Protocol (“IP”), File Transfer Protocol (“FTP”), Hypertext Transfer Protocol (“HTTP”), Simple Object Access Protocol (“SOAP”), Session Initiation Protocol (“SIP”), Extensible Markup Language (“XML”) formatted messages and variations thereof, Simple Mail Transfer Protocol (“SMTP”), Real-Time Transport Protocol (“RTP”), User Datagram Protocol (“UDP”), service calls (e.g., web service calls), data streaming technologies (e.g., media streaming technologies), socket connections, Ethernet, data and/or service bus technologies, service-oriented architecture technologies, and other suitable communications technologies.

Gateway device 104 may communicate with headset device 102 by way of wireless network 106 using any suitable communication technologies, devices, media, and/or protocols supportive of wireless signaling and/or data communications, including, but not limited to, data communications devices, network elements, one or more data communications protocols (including any of those mentioned above), data streaming technologies (e.g., media streaming technologies), and other communications technologies suitable for wireless communications by way of wireless network 106.

In addition to facilitating communications between service devices 108 and headset device 102, gateway device 104 may perform one or more operations to facilitate headset device 102 accessing hosted services provided by server devices 108. For example, gateway device 104 may establish and/or tear down communication paths, perform device and/or user authentication operations, route communications to/from appropriate server devices 108, translate communication messages (e.g., interpret and translate voice command input data received from headset device 102), and/or any other operations that may facilitate headset device 102 accessing hosted services provided by server devices 108. Accordingly, gateway device 104 may function as an access point through which headset device 102 may access one or more hosted services (e.g., a package of hosted services) provided by one or more server devices 108. In certain examples, gateway device 104 may be part of wireless network 106, such as a network node within wireless network 106.

Wireless network 106 may include any suitable wireless network or combination of wireless networks. For example, wireless network 106 may include one or more wireless wide area data networks, including, but not limited to Long Term Evolution (“LTE”), Global System for Mobile Communications (“GSM”), Code Division Multiple Access (“CDMA”), Time Division Multiple Access (“TDMA”), Evolution Data Optimized Protocol (“EVDO”), Short Message Service (“SMS”), Multimedia Message Service (“MMS”), and radio frequency (“RF”) based wireless wide area networks, or any combination or sub-combination thereof. Additionally or alternatively, wireless network 106 may include one or more other wireless networks, such as a wireless local area network (e.g., a Wi-Fi network). In certain implementations, wireless network 106 may include and/or communicate with other networks (e.g., the Internet) to facilitate communications between gateway device 104 and headset device 102.

Headset device 102 may be a computing device (with a processor and computer-readable memory) configured to perform one or more of the headset operations described herein. Headset device 102 may connect to wireless network 106 and communicate with gateway device 104 by way of the wireless network 106. Headset device 102 may include computing hardware (e.g., an LTE chipset, a Wi-Fi chipset, etc.) for connecting with and communicating over wireless network 106. Headset device 102 may utilize any suitable wireless communication technologies to connect to wireless network 106 and communicate with gateway device 104 by way of the wireless network 106.

In certain examples, headset device 102 may be equipped for one or more additional types of communications. For example, headset device 102 may be configured for communications with another device in local proximity to headset device 102, such as by way of near-field communications, Bluetooth communications, wired communications, and/or any other local communications technologies.

Headset device 102 may include a support structure that houses components of headset device 102 and that allows a user to wear headset device 102 as a headset. For example, headset device 102 may include a fabric support structure that allows the headset device 102 to be worn on the head of a user. In other examples, headset device 102 may be mounted to the head of the user in other suitable ways.

Headset device 102 may provide one or more user interfaces through which a user may interact with the headset device 102 and hosted services accessed by the headset device 102. As an example, headset device 102 may provide audio-based user interfaces through which the user may provide audio input and hear audio output. To this end, headset device 102 may include one or more microphones for receiving audio input and one or more speakers for providing audio output. In certain examples, through an audio user interface provided by headset device 102, the user may provide voice input commands to headset device 102 and/or one or more hosted services. In this manner, system 100 may provide an interactive voice response (“IVR”) interface through which the user may access and/or control one or more hosted services.

As another example, headset device 102 may provide one or more visual-based user interfaces. For instance, headset device 102 may include a heads-up display configured to display visual output (e.g., graphical user interface views) to the user. In certain examples, headset device 102 may also include a camera (e.g., a video and/or still-shot camera) for capturing visual images.

As another example, headset device 102 may provide one or more other types of user interfaces, such as motion-based and/or haptic-based input and/or output interfaces. For instance, a motion-based interface may allow the user to move his or her head (e.g., by nodding or shaking the head) to provide input. A haptic-based interface may allow the user to provide touch input (e.g., by way of a touch screen and/or physical buttons). Headset device 102 may include hardware to support motion-based and/or haptic-based input and/or output. For example, headset device 102 may include one or more motion sensors (e.g., accelerometers, gyroscopes, compasses (e.g., eCompass), etc.).

As another example, headset device 102 may provide one or more biometric user interfaces, such as a user interface through which biometric data about a user may be received. Headset device 102 may include hardware to support biometric user interfaces. For example, headset device 102 may include one or more biometric sensors, such as a heart rate sensor, an electromyography (“EMG”) sensor, an electrocardiogram (“ECG” or “EKG”) sensor, a blood pressure sensor, a blood oxygen sensor, a body temperature sensor, a brain activity sensor, and/or other type of biometric sensor.

A user of headset device 102 may use one or more of the user interfaces provided by headset device 102 to access and interact with one or more hosted services through gateway device 106. For example, the user may provide voice input commands to access and interact with a hosted service.

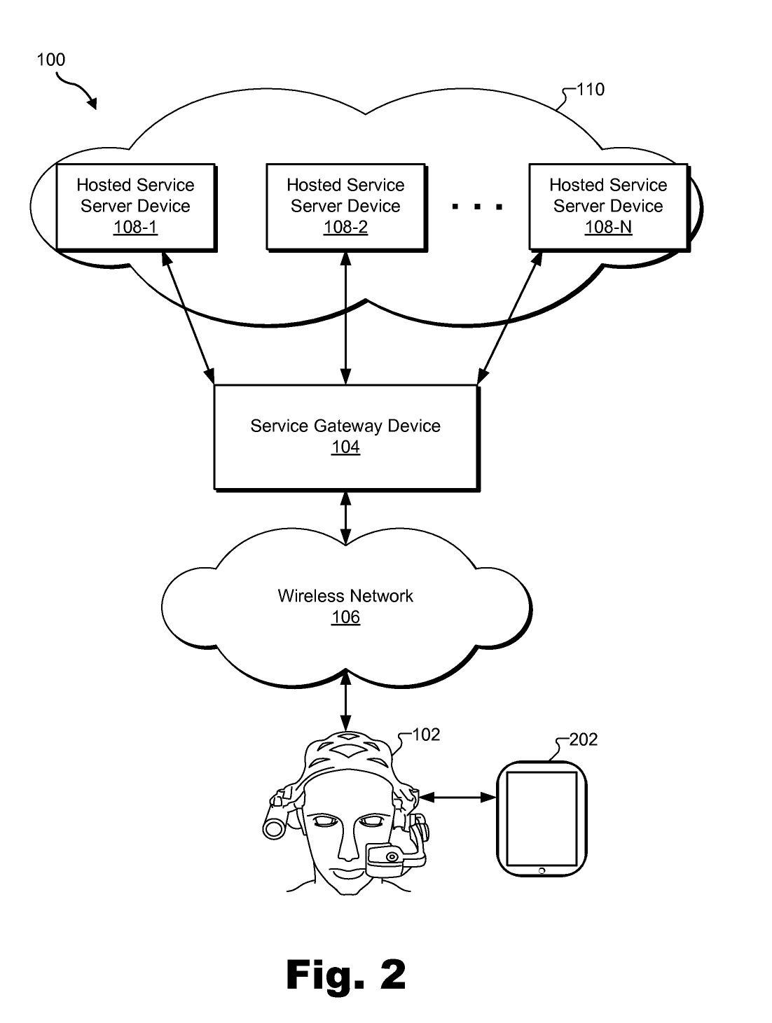

In certain examples, headset device 102 may be configured to connect to one or more peripheral devices that may be used by the user to provide input to and/or receive output from headset device 102. Headset device 102 may connect to a peripheral device in any suitable way, including by way of any of the local communications technologies disclosed herein. For example, headset device 102 may be connected to a gaming controller, a remote control device, a mobile computing device (e.g., a smartphone or tablet with a headset interface application installed thereon), and/or another handheld device. To illustrate, FIG. 2 shows system 100 with a mobile device 202 connected to headset device 102 as a peripheral input/output device. In this configuration, the user of headset device 102 may use mobile device 202 to provide input to (e.g., touch screen input) and/or to receive output from (e.g., graphical user interface output) headset device 102.

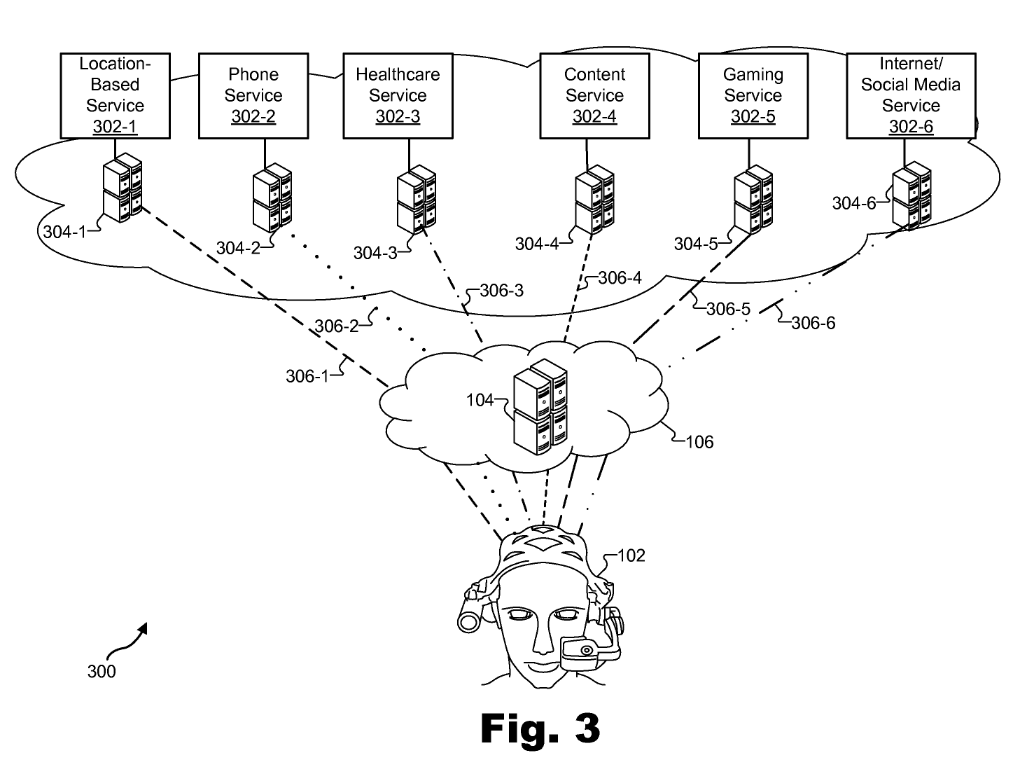

FIG. 3 illustrates an exemplary implementation 300 of system 100 in which a particular set of hosted cloud services 302 (e.g., cloud services 302-1 through 302-6) are provided by a set of server devices 304 (e.g., server devices 304-1 through 304-6) for access by headset device 102 through gateway device 104. Each of the server devices 304 may include one or more physical server devices configured to function to provide a corresponding one of the cloud services 302. In the illustrated example, server device 304-1 provides a location-based service 302-1, server device 304-2 provides a phone service 302-2, server device 304-3 provides a healthcare service 302-3, server device 304-4 provides a content storage and management service 302-4 (“content service 302-4”), server device 304-5 provides a gaming service 302-5, and server device 304-6 provides an Internet and/or social media service 302-6. In certain examples, these cloud services 302 or a subset of these cloud services 302 may be provided as a package of services for access by headset device 102 through gateway device 104.

FIG. 3 includes dashed lines 306 (e.g., dashed lines 306-1 through 306-6) representing communication paths between headset device 102 and server devices 304 by way of gateway device 104. The dashed lines 306 have different visual attributes (e.g., dash lengths and patterns) to distinguish the different paths.

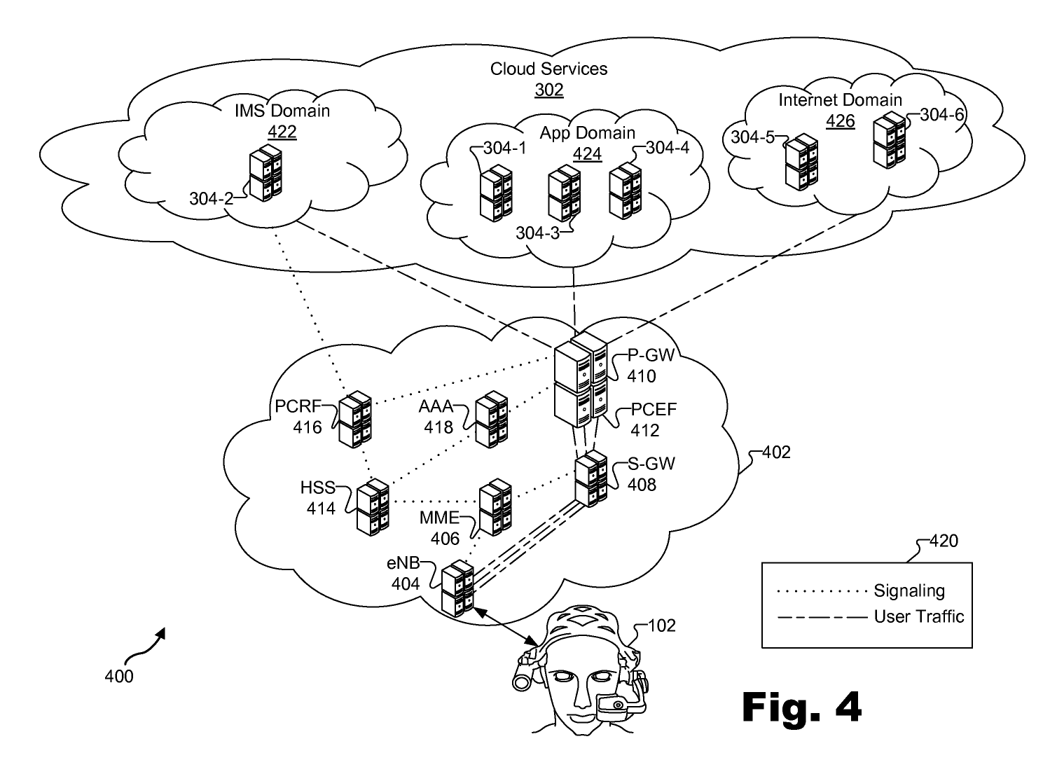

As mentioned, in certain examples, wireless network 106 may include a wireless wide area network, such as an LTE network. FIG. 4 illustrates an exemplary implementation 400 of system 100 in which wireless network 106 includes an LTE network 402. Certain components of LTE network 402 are shown. As illustrated, LTE network 402 may include an E-UTRAN Node B (“eNodeB” or “eNB”) 404 with which headset device 102 may communicate using wireless radio signaling to access LTE network 402. LTE network 402 may further include a mobility management entity (“MME”) 406, a serving gateway (“S-GW”) 408, a PDN gateway (“P-GW”) 410, a policy and charging enforcement function (“PCEF”) element 412, a home subscriber server (“HSS”) 414, a policy and charging rules function (“PCRF”) element 416, and an authentication, authorization, and account (“AAA”) server 418.

One or more of the components of LTE network 402 may be communicatively connected. In FIG. 4, for example, dotted lines may represent signaling between components of LTE network 402, and dashed lines may represent user traffic between components of LTE network 402. FIG. 4 includes a legend 420 indicating that a dotted line represents signaling and a dashed line represents user traffic.

S-GW 408 may route and forward user data packets between eNB 404 and P-GW 410. P-GW 410 may provide connectivity from LTE network 402 to one or more external packet data networks, including network domains in which server devices 304 are located. Gateway device 104 may be implemented by one or more of the components of LTE network 402 in implementation 400. For example, gateway device 104 may be entirely or partially implemented by P-GW 410.

As shown in FIG. 4, P-GW 410 may send and receive user traffic to/from server devices 304 that provide a set of cloud services 302. Server devices 304 may be implemented in different domains. For example, phone server device 304-2 that provides phone service 302-2 may be implemented in an Internet Protocol (“IP”) Multimedia Subsystem (“IMS”) domain 422, which may include an architectural framework for delivering and/or aiding access to IP multimedia services (e.g., voice application services). In addition, an applications domain 424 may implement location server device 304-1 that provides location-based service 302-1, healthcare server device 304-3 that provides healthcare service 302-3, and content server device 304-4 that provides content service 302-4. In addition, an Internet domain 426 may implement gaming server device 304-5 that provides gaming service 302-5 and Internet/social media server device 304-6 that provides Internet/social media service 302-6. P-GW 410 may send and/or receive user traffic to/from each of the domains 422, 424, and 426 such that P-GW 410 forms traffic pathways between headset device 102 and the server devices 304 in their respective domains 422, 424, and 426.

Exemplary configurations and features of hosted cloud services that may be provided by one or more server devices and accessed by a headset device by way of a gateway device will now be described.

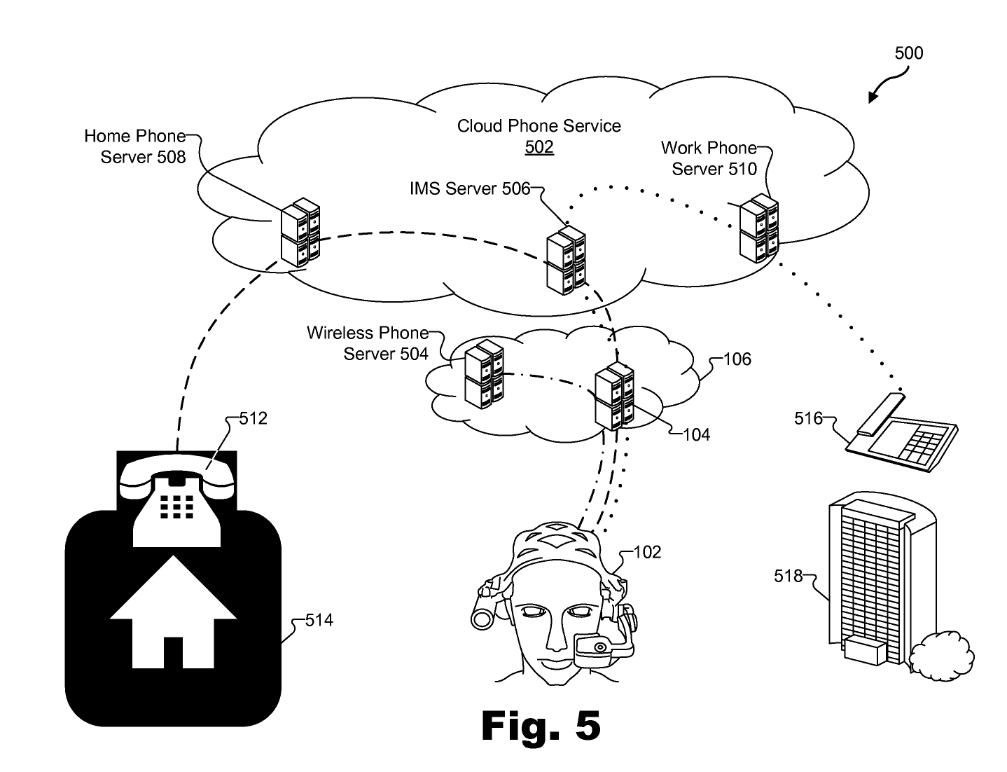

FIG. 5 illustrates an exemplary configuration 500 of a phone service that may be accessed by headset device 102 by way of gateway device 104 implemented in wireless network 106. The phone service may include a combination of different types of phone services, including, for example, a cloud phone service 502, one or more landline phone services, a wireless phone service (e.g., a cellular phone service), and/or any other type of phone service.

In configuration 500, wireless network 106 may support a wireless phone service, such as a cellular phone service. For example, wireless network 106 may include an LTE network configured to provide a wireless phone service. To this end, wireless network 106 may include one or more components configured to support the wireless phone service, such as a wireless phone server device 504 configured to provide one or more features of the wireless phone service for access by headset device 102.

Headset device 102 may include one or more components that enable headset device 102 to access and use the wireless phone service through gateway device 104. For example, headset device 102 may include a chipset for communicating with components of wireless network 106. Headset device 102 may also be assigned a mobile directory number (“MDN”) such that headset device 102 may originate outgoing voice calls and receive incoming voice calls, over wireless network 106, by way of the MDN. In certain examples, headset device 102 may be assigned multiple MDNs, each of which may be selectively used to originate outgoing voice calls and receive incoming voice calls over wireless network 106.

In addition or alternative to accessing a wireless phone service supported by wireless network 106, headset device 102 may be configured to access cloud phone service 502 through gateway device 104. In configuration 500, gateway device 104 is communicatively coupled to an IMS application server device 506, which is in turn communicatively coupled to a home phone server device 508 and a work phone server device 510. While configuration 500 illustrates an IMS-based architecture as an example, other suitable architectures, such as a non-IMS-based architecture, may be used in other configurations.

Home phone server device 508 may provide one or more features of a home phone service (e.g., a home landline phone service) that is accessible by way of a phone device 512 located at a home premises 514 of a subscriber to the home phone service. Similarly, work phone server device 510 may provide one or more features of a work phone service (e.g., a work landline phone service) that is accessible by way of a phone device 516 located at a work premises 518 of a subscriber to the work phone service.

IMS server device 506 may be configured to function as an anchor to the home phone service and the work phone service such that the services are anchored to an IMS-based phone infrastructure. Accordingly, headset device 102 may access the home phone service and the work phone service through gateway device 104 and IMS server device 506, which may allow headset device 102 to access one or more features of the home and work phone services. For example, through gateway device 104 and IMS server device 506, headset device 102 may originate outgoing calls and receive incoming calls associated with the home phone service and the work phone service. To illustrate, the home phone service may be associated with a home phone number assigned to a subscriber to the home phone service. Through gateway device 104 and IMS server device 506, headset device 102 may place outgoing calls from the home phone number and receive incoming calls directed to the home phone number. Similarly, the work phone service may be associated with a work phone number assigned to a subscriber to the work phone service. Through gateway device 104 and IMS server device 506, headset device 102 may place outgoing calls from the work phone number and receive incoming calls directed to the work phone number.

In this or a similar manner, headset device 102 may be associated with multiple phone numbers, such as multiple phone numbers associated with different phone service subscriptions and/or types of phone services. Inasmuch as the phone numbers may be assigned to different identities, headset device 102 may be said to have access to a multi-persona phone service, where each phone number provides a different phone persona. In such a configuration, a user of headset device 102 may use the headset device 102 to place outgoing calls from any of the phone numbers, or phone personas, accessible by headset device 102 and to receive incoming calls directed to any of the phone numbers, or phone personas, accessible by the headset device 102. For example, when the user wishes to place an outgoing call, the user may provide input to headset device 102 to select which of the phone numbers accessible by headset device 102 will be used to originate the call.

In configuration 500, headset device 102 may be said to have access to a multi-persona phone service, which may include a first persona for a wireless phone service, a second persona for a home landline phone service, and a third persona for a work landline phone service, for example. Each different persona or phone service may be associated with a unique phone number. For instance, the wireless phone service may be associated with a mobile directory number, the home landline phone service may be associated with a home phone number, and the work landline phone service may be associated with a work phone number.

As mentioned, headset device 102 may be configured to receive user voice commands as input to one or more hosted cloud services. For example, headset device 102 may receive user voice commands to control a phone service accessible by headset device 102. To illustrate one example, a user of headset device 102 may wish to place an outgoing voice call. The user may provide voice commands configured to direct headset device 102 to perform one or more operations to initiate an outgoing voice call. The user voice commands may specify which phone number to use to place the call, as well as a target destination for the call. For instance, the user may speak “call John from work number.” Headset device 102 may respond by performing one or more operations to place a call from the work phone number to a phone number associated with John.

To illustrate another example, the user may speak a voice command configured to cause headset device 102 to launch a call screen for display on a heads-up display of headset device 102. For example, the user may speak “call screen.” In response, headset device 102 may display a call screen on the heads-up display of headset device 102. The call screen may visually indicate one or more actions associated with a phone service accessible by headset device 102. For example, the call screen may indicate all of the phone numbers that are accessible by headset device 102 and that may be used to place an outgoing voice call. While the call screen is displayed, the user may provide an additional voice command to cause headset device 102 to perform one or more operations to access and/or use one or more features of the phone service. For example, the user may provide a voice command to select one of the phone numbers and/or to place a call from one of the phone numbers.

Headset device 102 may be configured in any suitable way to access multiple phone services. For example, headset device 102 may implement a client phone application for each phone service. Through a client phone application and gateway device 104, headset device 102 may access features of the phone service corresponding to the application.

In certain examples, headset device 102 may be configured to conference multiple active voice calls together. In this manner, headset device 102 may establish a conferencing bridge. In some examples, headset device 102 may include multiple personas in a conference call, such as by conferencing active calls associated with multiple phone numbers accessible by the headset device 102. For example, headset device 102 may conference together an active call that involves a mobile directory number of the headset device 102 and another active call that involves a home phone number accessible by the headset device 102.

In certain examples, headset device 102 may be configured to establish a voice communication session over a local connection with another headset device. For example, two headsets may pair with one another over a Wi-Fi or Bluetooth connection. When paired, the headsets may provide an intercom connection between the headsets. Headset 102 may pair with multiple other headsets to establish a multi-user intercom session.

In FIG. 5, dashed lines represent paths between headset device 102 and phone service devices (e.g., wireless phone server device 504, home phone server device 508, phone device 512, work phone server device 510, and phone device 516). Signaling and/or user traffic may be transmitted over any of the paths. The dashed lines have different visual attributes (e.g., dash lengths and patterns) to distinguish the different paths.

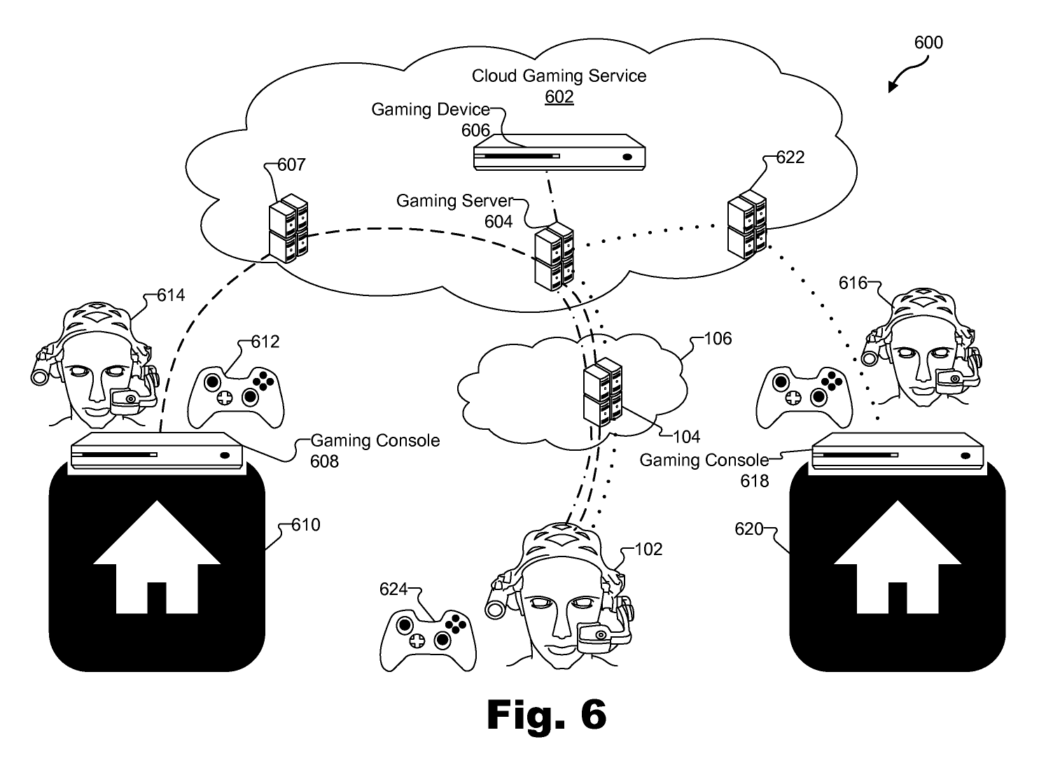

FIG. 6 illustrates an exemplary configuration 600 of a gaming service that may be accessed by headset device 102 by way of gateway device 104 implemented in wireless network 106. The gaming service may include a combination of different types and/or features of gaming services, including, for example, a cloud gaming service 602, access to remote gaming consoles (e.g., a gaming console located at a user premises), and/or local gaming (e.g., when a headset 102 does not have connectivity to online or remote gaming features).

Headset device 102 may include one or more components that enable headset device 102 to access and use the gaming service through gateway device 104. For example, headset device 102 may include a gaming application configured to communicate with a gaming server device 604 by way of gateway device 104. As shown, gaming server device 604 may be communicatively coupled to gateway device 104. Gaming server device 604 may also implement or be communicatively coupled to a cloud-based gaming device 606.

Cloud-based gaming device 606 may be configured to perform one or more gaming operations to provide cloud gaming service 602 for access by headset device 102 by way of gateway device 104 and gaming server device 604. For example, cloud-based gaming device 606 may perform operations to host a game, including establishing a gaming session, joining the headset device 102 to the gaming session, receiving input to the game from the headset device 102, and providing output from the game to the headset device 102. Accordingly, through gateway device 104 and gaming server 604, headset device 102 may access cloud gaming service 602 and allow the user of headset device 102 to interact with cloud gaming service 602, including by playing a game hosted by cloud-based gaming device 606.

In certain examples, a cloud-based game hosted by cloud-based gaming device 606 may include a multi-player game. For example, multiple users using multiple headset devices 102 may join and play a multi-player game hosted by cloud-based gaming device 606. In such a configuration, cloud-based gaming device 606 may perform operations to run the game, including establishing a gaming session, joining the headset devices 102 to the gaming session, receiving input to the game from the headset devices 102, and providing output from the game to the headset devices 102.

In addition or alternative to cloud gaming service 602 providing headset device 102 with access to games hosted by cloud-based gaming device 606, in certain examples cloud gaming service 602 may provide headset device 102 with access to games hosted by gaming devices other than a cloud-based gaming device 606. For example, cloud gaming service 602 may provide headset device 102 with access to a game provided by a gaming console device located at a user premises.

To illustrate, in configuration 600, gaming server 604 is communicatively coupled to a home gateway device 607, which in turn is communicatively coupled to a gaming console device 608 located at a home premises 610 of a user of the gaming console device 608. Through gateway device 104, gaming server device 604, and home gateway device 607, headset device 102 may interact with gaming console device 608. Such interactions may include headset device 102 logging in to gaming console device 608, providing input to gaming console device 608, receiving output provided by gaming console device 608, joining a gaming session hosted by gaming console device 608, providing gaming input to the game, and/or receiving gaming output from the game. Accordingly, a user of headset device 102 may join and participate in a game hosted by gaming console device 608. This may allow the user to use headset device 102 to access and play a game on gaming console device 608 even when the user is away from home premises 610.

In certain examples, the user of headset device 102 may use headset device 102 to join and participate in a multi-player game hosted by gaming console device 608. For example, a person located at home premises 610 may start and participate in a game hosted by gaming console device 608. This user may use any suitable device to interact locally with gaming console device 608, such as a gaming remote controller device 612 or an additional headset device 614 located at customer premises 610 and communicatively connected to gaming console device 608 by way of a local connection. The user of headset device 102 may join and participate in the game together with the user located at home premises 610. For example, while on a business trip the user of headset device 102 may use headset device 102 to join and participate in a game with the user's child who is located at home premises 610 and is using gaming remote controller device 612 and/or the additional headset device 614 to concurrently participate in the game.

In certain examples, any suitable number and/or configuration of headset devices and/or user premises gaming console devices may join a gaming session hosted by a particular gaming device. In the exemplary configuration 600 shown in FIG. 6, for example, any combination of headset device 102, headset device 614, gaming console device 608, an additional headset device 616, and an additional gaming console device 618 located at an additional home premises 620 may join a gaming session hosted by gaming console device 608, gaming console device 618, or cloud-based gaming device 606. Gaming console device 618 may host or join a remotely hosted game by way of home gateway 622, which is communicatively coupled to gaming server 604.

In certain examples, a gaming device may be configured to host multiple users configured as groups of users. For instance, the gaming device may host a game in which teams of players compete against one another as teams. For example, the gaming device may host a game in which a team of three players competes with another team of three other players. For example, cloud-based gaming device 606, together with gaming server device 604, may connect multiple players and/or teams of players together to play a multi-player game as a group.

In certain examples, a headset device may be configured to interact locally with a user-premises gaming console device. For example, headset device 616 may communicate with gaming console device 618 over a local connection (e.g., a Wi-Fi network connection) such that a user of headset device 616 may use headset device 616 to play games hosted by gaming console device 618.

In certain examples, multiple users of multiple headset devices and/or gaming remote controller devices may join and participate, through one or more local connections, in a game hosted by a user-premises gaming console device. For example, multiple headset devices may be located at home premises 620, connect to gaming console device 618 by way of a local area network (e.g., a Wi-Fi network), and join and participate in a multi-player game hosted by the gaming console device 618.

In certain examples, headset device 102 may be configured to store and run games locally. For example, a game may be stored in local memory of headset device 102 and executed by a processor of headset device 102. Accordingly, headset device 102 may operate as a standalone gaming console in certain examples, such as when headset device 102 does not have connectivity to online or remote gaming features (e.g., during airplane travel).

Headset device 102 may be configured to receive any suitable user input as input to a game session to which the headset device 102 is connected. As an example, headset device 102 may be configured to detect motion-based user input as input to a game. To illustrate, the user of headset device 102 may act out certain motions of his or her head to provide input to the game, including, but not limited to, tilting, nodding, shaking, or otherwise moving his or her head. As another example, a gaming remote controller device 624 may be communicatively coupled to headset device 102 by way of a local connection such that the user of headset device 102 may hold and use gaming remote controller device 624 to provide input to headset device 102, which may forward the input to a game session to which headset device 102 is connected. As another example, headset device 102 may be configured to receive voice input as input to a game.

In FIG. 6, dashed lines represent paths between headset device 102 and gaming devices 606, 608, and 618. Signaling and/or user traffic may be transmitted over any of the paths. The dashed lines have different visual attributes (e.g., dash lengths and patterns) to distinguish the different paths.

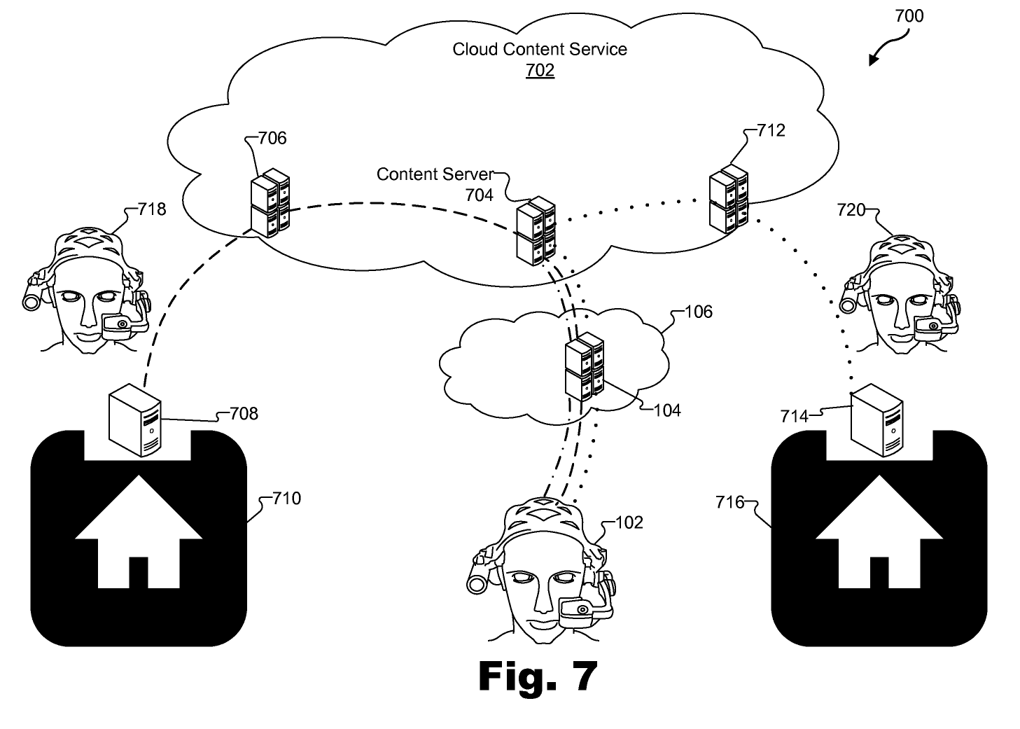

FIG. 7 illustrates an exemplary configuration 700 of a content service that may be accessed by headset device 102 by way of gateway device 104 implemented in wireless network 106. The content service may include a combination of different types and/or features of content services, including, for example, a cloud-based content service 702 for storing, managing, and accessing content stored locally by headset device 102, by a cloud-based content server device 704, and/or by one or more other content storage devices to which a user has access rights (e.g., a personal computer located at a user premises).

Headset device 102 may include one or more components that enable headset device 102 to access and use the content service through gateway device 104. For example, headset device 102 may include a content management and/or access application (e.g., a digital video recorder application, a set-top box application, an on-demand content application, etc.) configured to communicate with content server device 704 by way of gateway device 104. As shown, content server device 704 may be communicatively coupled to gateway device 104.

Content server device 704 may be configured to perform one or more content storage, management, and/or delivery operations to provide cloud-based content service 702 for access by headset device 102 by way of gateway device 104. For example, content server device 704 may perform operations to store content, manage content, and deliver (e.g., stream) content to the headset device 102. Accordingly, through gateway device 104, headset device 102 may be used by a user to store and manage content stored by content server device 704, and to access cloud-based content service 702 and consume content stored by content server device 704.

The content may include any form or type of content that may be digitally stored by content server device 704 and remotely managed and/or accessed (e.g., by a user of headset device 102). For example, the content may include media content such as audio programs (e.g., music, songs, audiobooks, etc.), video programs (e.g., movies, television programs, captured and/or recorded video, etc.), images (e.g., photos), and/or any other type of media content.

In addition or alternative to cloud-based content service 702 providing headset device 102 with access to cloud-hosted content, in certain examples cloud-based content service 702 may provide headset device 102 with access to content hosted by content storage devices other than a cloud-based content storage device. For example, cloud-based content service 702 may provide headset device 102 with access to content stored by a computing device located at a user premises.

To illustrate, in configuration 700, content server device 704 is communicatively coupled to a home gateway device 706, which in turn is communicatively coupled to a computing device 708 located at a home premises 710 of a user of the computing device 708. Through gateway device 104, content server device 704, and home gateway device 706, headset device 102 may interact with computing device 708. Such interactions may include headset device 102 logging in to computing device 708, providing input to computing device 708, receiving output provided by computing device 708, managing content stored by computing device 708 (e.g., uploading and storing content to computing device 708, deleting content from computing device 708, and/or modifying content stored by computing device 708), and/or access content stored by computing device 708 (e.g., by streaming content from computing device 708). This may allow a user to use headset device 102 to access and consume content stored by computing device 708 even when the user is away from home premises 710.

Headset device 102 may have access to content stored by more than one remotely located, non-cloud-based computing device. In configuration 700, for example, content server device 704 is communicatively coupled to an additional home gateway device 712, which in turn is communicatively coupled to a computing device 714 located at a home premises 716 of a user of the computing device 714. Through gateway device 104, content server device 704, and home gateway device 712, headset device 102 may interact with computing device 714 similar to how headset device 102 may interact with computing device 708, as described above. This may allow a user to use headset device 102 to access and consume content stored by computing device 714 even when the user is away from home premises 716.

In certain examples, a headset device may be configured to interact locally with a computing device. For example, FIG. 7 shows an additional headset device 718 located proximate to computing device 708 such that headset device 718 may communicate with computing device 708 over a local connection (e.g., a Wi-Fi network connection) such that a user of headset device 718 may use headset device 718 to manage and access content stored and/or accessed by computing device 708 by way of the local connection. Similarly, an additional headset device 720 located proximate to computing device 714 may communicate with computing device 714 over a local connection (e.g., a Wi-Fi network connection) such that a user of headset device 720 may use headset device 720 to manage and access content stored and/or accessed by computing device 714 by way of the local connection. To illustrate one example, computing device 708 may be a set-top box device configured to access media content and to stream the accessed media content to headset device 718 over a local connection.

In certain examples, headset device 102 may be configured to store content locally. For example, content may be stored in local memory of headset device 102 such that the content may be locally managed and accessed by a user of headset device 102.

In certain examples, headset device 102 may be configured to access content, such as music library content, stored by any content storage device to which a user of headset device 102 has permission to access. For example, headset device 102 may be configured to access content stored locally by headset device 102, cloud-based content stored and/or accessible by content server device 704, and/or content stored by computing device 708 and/or computing device 714.

To illustrate one example, a user of headset device 102 may want to access and listen to certain music while playing a game through cloud-based gaming service 602. The user may provide input to headset device 102 to instruct headset device 102 to access and play back the music during a gaming session for the game.

To illustrate another example, users of headset devices may concurrently access and experience a media program (e.g., a movie) while located remotely from one another. The users may use the headset devices to communicate one with another during presentation of the media programs, such as by text messaging, media messaging, and/or voice calls. In certain examples, one or more of the users may be able to provide input to control the playback of the media program for all users who are participating in the playback session.

Headset device 102 may be configured to receive any suitable user input as input to manage and/or access content. For example, headset device 102 may be configured to receive voice input as input to initiate one or more content management and/or access operations. Any other type of input may be used alternative or in addition to such voice input to initiate one or more content management and/or access operations.

In FIG. 7, dashed lines represent paths between headset device 102 and content server device 704, computing device 708, and computing device 714. Signaling and/or user traffic may be transmitted over any of the paths. The dashed lines have different visual attributes (e.g., dash lengths and patterns) to distinguish the different paths.

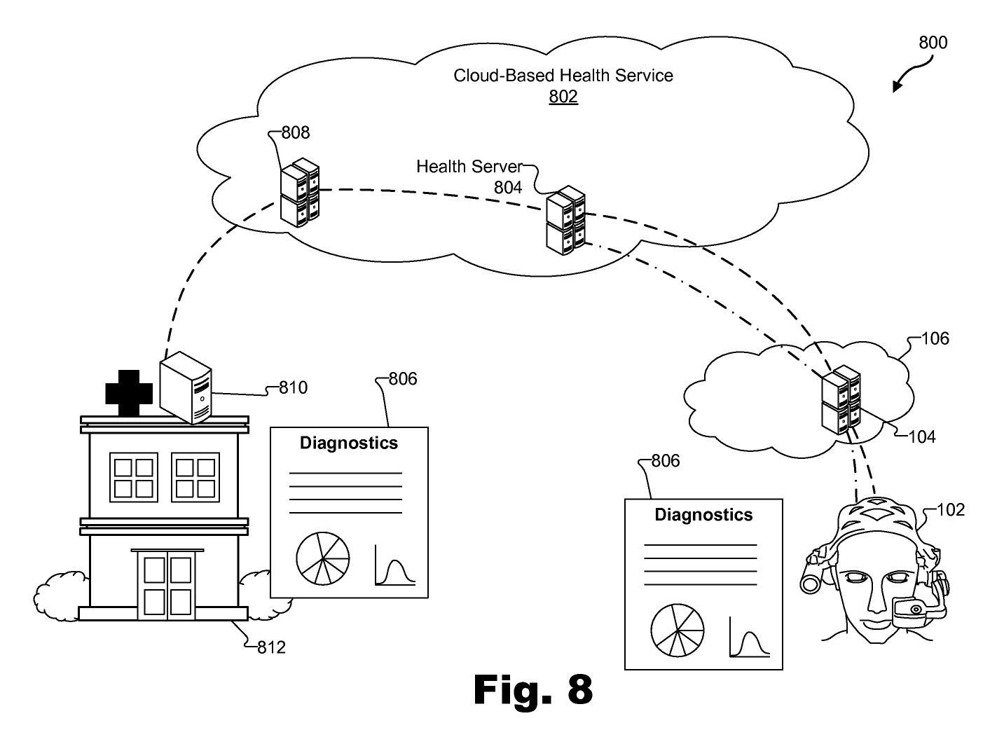

FIG. 8 illustrates an exemplary configuration 800 of a health service that may be accessed by headset device 102 by way of gateway device 104 implemented in wireless network 106. The health service may include a combination of different types and/or features of health services, including, for example, a cloud-based health service 802.

Headset device 102 may include one or more components that enable headset device 102 to access and use the health service through gateway device 104. For example, headset device 102 may include a health application configured to communicate with a health server device 804 by way of gateway device 104. As shown, health server device 804 may be communicatively coupled to gateway device 104.

In certain examples, headset device 102 may include one or more authentication tools for authenticating a user of headset device 102 before granting access to the health service and/or sensitive medical information. For example, headset device 102 may use retina recognition technologies to authenticate a user of headset device 102.

Headset device 102 may include one or more sensors configured to gather data related to the health of a user of headset device 102. For example, headset device 102 may include one or more biometric sensors configured to gather data representative of the health of the user, including vital statistics for the user. The sensors may include any set of biometric sensors, including any of those disclosed herein.

In addition, headset device 102 may be configured to communicate with one or more peripheral sensor devices to obtain data gathered by the peripheral sensor devices. For example, headset device 102 may communicate, by way of a local connection (e.g., a Bluetooth connection) with a thermometer device positioned at a particular place on the body of the user in order to obtain temperature data gathered by the thermometer device.

Headset device 102 may display data representative of and/or based on data gathered by the sensors. For example, headset device 102 may provide a health screen 806 (e.g., a health diagnostics and/or dashboard screen) for display on the heads-up display of headset device 102. Accordingly, the user of headset device 102 may view information about the health condition of the user. In certain examples, headset device 102 may gather sensor data and generate and provide health screen 806 based on the sensor data in a closed loop within the headset device 102. In other examples, headset device 102 may gather and provide sensor data to health server device 804, which may aggregate and provide health data for inclusion in health screen 806. In other examples, headset device 102 may use a combination of data received from health server device 804 and generated by headset device 102 based on gathered sensor data to generate and provide health screen 806 for display. Health screen 806 may include any content related to the health of the user of headset device 102, including content that is generated based on gathered sensor data.

Headset device 102 may provide health data to health server device 804 in any suitable way, including by streaming the health data to health server device 804 in real time by way of gateway device 104. Similarly, health server device 804 may provide content to headset device 102 in any suitable way, including by streaming the content to headset device 102 in real time by way of gateway device 104. In certain examples, health server device 804 may be configured to provide health-related information such as first aid instructions, diagnostic information, medical records, health condition reports, etc.

In certain examples, cloud-based health service 802 may provide a user of headset device 102 with access to a remote session with a healthcare provider, such as a doctor. As shown in FIG. 8, health server device 804 may be communicatively coupled to a healthcare provider gateway device 808, which in turn is communicatively coupled to a computing device 810 located at healthcare service premises 812.

Through healthcare provider gateway device 808, computing device 810 may join a remote session hosted by health server device 804. Accordingly, a healthcare provider may use computing device 810 to join and participate in a remote session (e.g., video conference session). The user of headset device 102 may use headset device 102 to join and participate in the remote session. Accordingly, the healthcare provider and the user of headset device 102 may interact one with another by way of the remote session. This may allow the healthcare provider to provide one or more health care services to the user of headset device 102, such as remote health diagnostic, checkup, or other health-related services.

In certain examples, health condition data gathered and/or generated based on sensors may be provided to computing device 810 for use by the healthcare provider. Accordingly, the healthcare provider may have access to health condition information useful for providing one or more healthcare services. In certain examples, health server device 804 may provide the same or similar health screen for display by computing device 810 and by headset device 102. FIG. 8 shows that health screen 806 may be displayed by headset device 102 and that another instance of the health screen 806 may be displayed at healthcare service premises 812.

In certain examples, headset device 102 may be used for monitoring (e.g., real time monitoring) of a user of headset device 102, such as a patient of a health services provider. Headset device 102 may be configured to detect, from sensor data gathered by headset device 102, a potential health emergency situation and alert the health service provider or one or more other predetermined contacts of the detected potential emergency situation. For example, headset device 102 may automatically initiate a call to an emergency services provider (e.g., 911 emergency services) when a potential health problem is detected.

In FIG. 8, dashed lines represent paths between headset device 102 and health server device 804, gateway device 808, and computing device 810. Signaling and/or user traffic may be transmitted over any of the paths. The dashed lines have different visual attributes (e.g., dash lengths and patterns) to distinguish the different paths.

Headset device 102 may be configured to access one or more location-based services, such as location based service 302-1, through gateway device 104. A location-based service may include any cloud-based service that may be provided to headset device 102 based on a geographic location of headset device 102. To support such services, headset device 102 may include components (e.g., a Global Positioning System (“GPS”) chipset) configured to support location tracking of headset device 102. Examples of location-based services and services that leverage location-based services will now be described.

In certain examples, headset device 102 may be configured to send an emergency message in response to receiving predefined input (e.g., detecting a predefined voice command such as “help me”). Headset device 102 may send the message to a predefined list of one or more recipients. The message may include information indicating the geographic location of headset device 102 (e.g., within a house, a neighborhood, etc.). Headset device 102 may be configured with multiple different messages mapped to multiple different inputs. Each message may be set up to be directed to a particular set of recipients.

In certain examples, a predefined input for an automatic message may include headset device 102 being moved outside of a predefined geographic location. Repeat messages may be sent periodically until headset device 102 returns within the predefined geographic location.

In certain examples, a predefined input for an automatic message may include headset device 102 being located outside of a predefined geographic location within a predefined time window. For example, a parent may define geographic and time boundaries. If headset device 102 is outside of those boundaries, headset device 102 may send an alert message (e.g., to a device associated with the parent).

In certain examples, a predefined input for an automatic message may include headset device 102 moving faster than a preselected speed for a particular geographic location. For example, if the headset device 102 moves at a speed that is at least a predefined threshold faster than a speed limit on a particular roadway, headset device 102 may send an alert message (e.g., to a device associated with a parent). Similar message may be triggered by other attributes of the headset device 102, such as sudden drops in height above a predefined threshold, an abrupt stop of the headset device 102 after traveling at least as fast as a predefined speed (which may indicate an automobile collision), and any other defined changes in attributes of headset device 102. Message trigger thresholds may be defined for a variety of use cases, such as to determine unsafe driving conditions (e.g., driver impairment, etc.)

In certain examples, one or more attributes of headset device 102 may be tracked for any suitable application, such as a physical fitness application. For example, attributes of headset device 102 such as distance traveled, speed, pace, time, altitude change, route, etc. may be tracked.

Headset device 102 may be configured to access one or more connectivity services, such as Internet/social media service 302-6, through gateway device 104. An Internet service may provide headset device 102 with access to the Internet. For example, through an Internet service, headset device 102 may browse the World Wide Web. A social media service may provide headset device 102 with access to one or more social media platforms. Through a social media service, headset device 102 may synchronize with and/or allow a user of headset device 102 to view and interact with one or more social media accounts of the user.

In certain implementations, headset device 102 may be configured to facilitate authentication of headset device 102 and/or a user of headset device 102 to one or more of the services accessible by way of headset device 102 before granting access to the service(s). The authentication may be facilitated in any suitable way, such as by using biometric user recognition technologies (e.g., retina recognition).

In certain implementations, headset device 102 may be configured to communicate with an external remote control device usable by a user to remotely control headset device 102 (e.g., when the user is not wearing headset device 102). For example, headset device 102 may be connected to a television device and used to play back a video program on the television device. In this configuration, a user of headset device 102 may be a distance away from the headset device 102 (e.g., sitting on a couch) and may use an external remote control device to remotely control operations of headset device 102.

In certain implementations, the external remote control device may be a mobile computing device (e.g., a mobile phone or tablet computer) with a client application (e.g., a mobile “app”) installed to configure the mobile computing device to interact with headset device 102. Accordingly, a user may utilize the mobile computing device to control operations of headset device 102. This may allow the user to utilize the mobile computing device to access one or more hosted services by way of headset device 102, without wearing headset device 102.

In certain implementations, headset device 102 may include an integrated or be connected to an external antenna system such that headset device 102 may function as local wireless network hotspot (e.g., a Wi-Fi hotspot router and/or access point). In such implementations, headset device 102 may connect to a wide area network (e.g., an LTE network) to provide the devices connected to the local wireless network with access to hosted services and/or content.

In certain implementations, headset device 102 may be configured to provide and/or access an image recognition service. For example, headset device 102 may include image recognition capabilities and/or be configured to access hosted image recognition capabilities useful for analyzing images captured by a camera of headset device 102. Such image recognition capabilities may be used to recognize images of people and/or determine identities of people from the images. For example, image recognition technologies may be used to identify persons of interest to a user of headset device 102. To illustrate, security personnel may use headset device 102 to identify a person who is of interest to law enforcement. To illustrate another example, a user of headset device 102 may use headset device 102 identify potential threats such as bullies or public offenders. Headset device 102 may alert the user of headset device 102 or other contacts (e.g., authorities) when a person of interest is detected.

In certain implementations, a hosted service may provide a backend portal (e.g., web portal) through which a user or third party may access the hosted service and/or information obtained by headset device 102 as part of the service. For example, a person who has been given login credentials by a user of headset device 102 may access the portal and view (e.g., in real time) a video camera feed of video images captured by a camera of headset device 102. For example, a person who has been given login credentials by the user of headset device 102 may log in to the portal (and consequently to headset device 102) and witness and/or record video footage of an event captured by headset device 102.

As mentioned, headset device 102 may include sensors for gathering data about the headset device 102, such as the speed, location, acceleration, environment, etc. of headset device 102. For example, headset device 102 may include one or more accelerometers, speedometers, altimeters, gyroscopes, etc. Data gathered by such sensors may be used to monitor the location, speed, and/or other attributes of headset device 102 and to detect potential predetermined situations. As an example, from sensor data, headset device 102 may detect that the user of headset device 102 has potentially experienced an accident (e.g., a vehicular accident). As another example, from sensor data (e.g., data representing head movements of the user), headset device 102 may detect that the user is potentially intoxicated, sleepy, or sleeping (e.g., when the user is driving, working, watching a movie, or participating in another activity). Headset device 102 may be configured to alert the user and/or other interested parties of such detected situations.

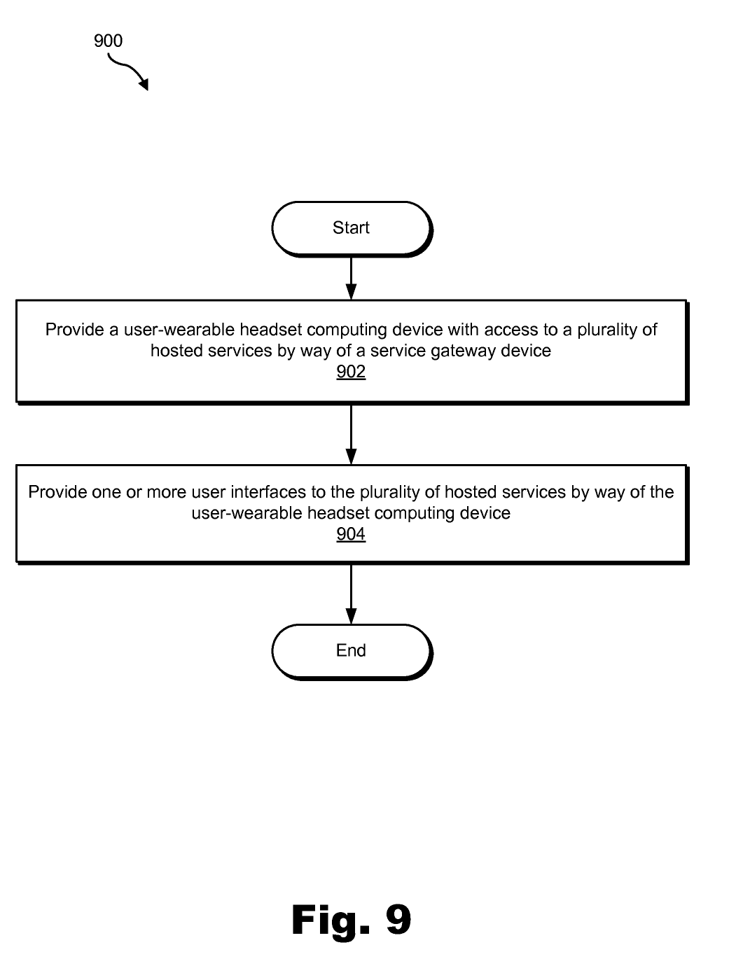

FIG. 9 illustrates an exemplary hosted service access method 900. While FIG. 9 illustrates exemplary steps according to one embodiment, other embodiments may omit, add to, reorder, combine, repeat, and/or modify any of the steps shown in FIG. 9. In certain embodiments, one or more of the steps shown in FIG. 9 may be performed by one or more components of system 100.

In step 902, a user-wearable headset computing device is provided with access to a plurality of hosted services by way of a service gateway device. Step 902 may be performed in any of the ways described herein, and the hosted services may include any combination of the exemplary hosted services described herein.

In step 904, one or more user interfaces to the plurality of hosted services is provided by way of the user-wearable headset computing device. Step 904 may be performed in any of the ways described herein, and the user interface(s) may include any of the exemplary user interfaces described herein. In certain examples, the user interface(s) includes an IVR user interface to one or more of the hosted services.

In certain embodiments, one or more of the components and/or processes described herein may be implemented and/or performed by one or more appropriately configured computing devices. To this end, one or more of the systems and/or components described above may include or be implemented as one or more computing systems and/or components by any computer hardware, computer-implemented instructions (e.g., software) embodied in a non-transitory computer-readable medium, or combinations of computer-implemented instructions and hardware, configured to execute one or more of the processes described herein. In particular, system components may be implemented on one physical computing device or may be implemented on more than one physical computing device. Accordingly, system components may include any number of physical computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (DRAM), which typically constitutes a main memory. Common forms of computer-readable media include, for example, a floppy disk, flexible disk, hard disk, magnetic tape, any other magnetic medium, a Compact Disc Read-Only Memory (CD-ROM), DVD, any other optical medium, a Random-Access Memory (RAM), a Programmable ROM (PROM), an Erasable PROM (EPROM), a Flash Electrically EPROM (FLASH-EEPROM), any other memory chip or cartridge, or any other tangible medium from which a computer may read.

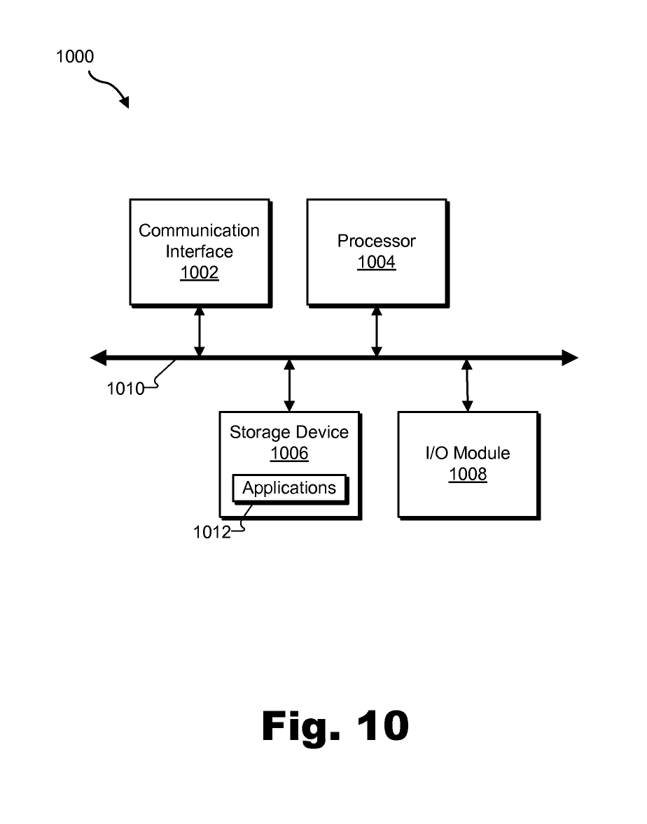

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (I/O) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, and any other suitable interface. In at least one embodiment, communication interface 1002 may provide a direct connection via a direct link to a network, such as the Internet. Communication interface 1002 may additionally or alternatively provide such a connection through, for example, a local area network (such as an Ethernet network), a personal area network, a telephone or cable network, a satellite data connection, a dedicated URL, or any other suitable connection. Communication interface 1002 may be configured to interface with any suitable communication media, protocols, and formats, including any of those mentioned above.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (RAM), dynamic RAM (DRAM), other non-volatile and/or volatile data storage units, or a combination or sub-combination thereof. Electronic data, including data described herein, may be temporarily and/or permanently stored in storage device 1006. For example, data representative of one or more executable applications 1012 (which may include, but are not limited to, one or more of the software applications described herein) configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the components of system 100 and/or implementations thereof described herein may be implemented by or within one or more components of computing device 1000. For example, one or more applications 1012 residing within storage device 1006 may be configured to direct processor 1004 to perform one or more processes or functions associated with system 100, or any components or implementations thereof.

To the extent the aforementioned embodiments collect, store, and/or employ personal information provided by individuals (or other entities), it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A system comprising:
a user-wearable headset computing device that includes a microphone, an audio speaker, and a heads-up display;
a service gateway device communicatively coupled to the user-wearable headset computing device by way of a wireless wide area network; and
a plurality of server devices communicatively coupled to the service gateway device and that provide a plurality of hosted services for access by the user-wearable headset computing device by way of the service gateway device, the plurality of hosted services comprising at least a multi-persona phone service and a content storage and management service;
wherein the user-wearable headset computing device and the service gateway device provide an interactive voice response user interface to the plurality of hosted services.

2. The system of claim 1, wherein the multi-persona phone service comprises:
a first persona for a wireless phone service;
a second persona for a home phone service; and
a third persona for a work phone service.

3. The system of claim 2, wherein:
the wireless phone service is associated with a mobile directory number;
the home phone service is associated with a home phone number; and
the work phone service is associated with a work phone number.

4. The system of claim 2, wherein the plurality of server devices comprises:
a home phone server device that provides the home phone service;
a work phone server device that provides the work phone service; and
an Internet Protocol Multimedia Subsystem server device communicatively coupled to the service gateway device, the home phone server device, and the work phone server device.

5. The system of claim 1, wherein the content storage and management service facilitates:
the user-wearable headset computing device accessing, by way of the service gateway device, media content stored by a cloud-based content server device; and
the user-wearable headset computing device remotely accessing, by way of the service gateway device and a home gateway device, media content stored by a computing device located at a user premises.

6. The system of claim 1, wherein the plurality of hosted services further comprises a gaming service for access by the user-wearable headset computing device by way of the service gateway device.

7. The system of claim 6, wherein the plurality of server devices comprises a gaming server device configured to provide the user-wearable headset computing device with access to a game hosted by a cloud-based gaming device.

8. The system of claim 6, wherein the plurality of server devices comprises a gaming server device configured to provide the user-wearable headset computing device with access to a game hosted by a gaming console device located at a user premises that is remote from the user-wearable headset computing device.

9. The system of claim 8, wherein the game hosted by the gaming console device located at the user premises that is remote from the user-wearable headset computing device comprises a multi-player game that includes a user of the user-wearable headset computing device and a user of the gaming console device.

10. The system of claim 1, wherein the plurality of hosted services further comprises a cloud-based health service for access by the user-wearable headset computing device by way of the service gateway device.

11. The system of claim 10, wherein the plurality of server devices comprises a health server device configured to host a remote video conference session between a user of the user-wearable headset computing device and a healthcare provider.

12. The system of claim 1, wherein the plurality of hosted services further comprises at least one of:
an Internet connection service;
a social media connection service; and
a location-based service.

13. The system of claim 1, wherein the wireless wide area network comprises a Long Term Evolution (“LTE”) wireless network.

14. The system of claim 1, further comprising a peripheral computing device communicatively coupled to the user-wearable headset computing device by way of a local connection and that provides an additional user interface to the user-wearable headset computing device, the additional user interface being different from the interactive voice response user interface.

15. A system comprising:
a user-wearable headset computing device that includes a microphone, an audio speaker, and a heads-up display;
a service gateway device communicatively coupled to the user-wearable headset computing device by way of a wireless wide area network; and
a plurality of server devices communicatively coupled to the service gateway device and configured to provide a plurality of hosted phone services for access by the user-wearable headset computing device by way of the service gateway device, the plurality of hosted phone services comprising a wireless phone service, a home phone service, and a work phone service.

16. The system of claim 15, wherein:
the wireless phone service is associated with a mobile directory number;
the home phone service is associated with a home phone number; and
the work phone service is associated with a work phone number.

17. The system of claim 15, wherein the plurality of server devices comprises:
a home phone server device that provides the home phone service;
a work phone server device that provides the work phone service; and
an Internet Protocol Multimedia Subsystem server device communicatively coupled to the service gateway device, the home phone server device, and the work phone server device.

18. The system of claim 15, wherein the user-wearable headset computing device and the service gateway device provide an interactive voice response user interface to the plurality of hosted phone services.

19. A method comprising:
providing, by a hosted-service access system, a user-wearable headset computing device that includes a microphone, an audio speaker, and a heads-up display with access to a plurality of hosted services by way of a service gateway device communicatively coupled to
the user-wearable headset computing device by way of a wireless wide area network, and
a plurality of server devices that provide the plurality of hosted services, the plurality of hosted service comprising at least a multi-persona phone service and a content storage and management service; and
providing, by the hosted-service access system, an interactive voice response user interface to the plurality of hosted services by way of the user-wearable headset computing device.

20. The method of claim 19, wherein the multi-persona phone service comprises:
a first persona for a wireless phone service associated with a mobile directory number;
a second persona for a home phone service associated with a home phone number; and
a third persona for a work phone service associated with a work phone number.

21. The method of claim 19, wherein the plurality of hosted services further comprises:
a gaming service for access by the user-wearable headset computing device by way of the service gateway device; and
a cloud-based health service for access by the user-wearable headset computing device by way of the service gateway device.

22. The method of claim 19, wherein the providing the user-wearable headset computing device with access to the plurality of hosted services by way of the service gateway device comprises providing the content storage and management service by facilitating:
the user-wearable headset computing device accessing, by way of the service gateway device, media content stored by a cloud-based content server device; and
the user-wearable headset computing device remotely accessing, by way of the service gateway device and a home gateway device, media content stored by a computing device located at a user premises.

23. The method of claim 19, embodied as computer-executable instructions on at least one non-transitory computer-readable medium.
